(19) United States
(12) Patent Application Publication
(10) Pub. No.: US 2022/0036400 A1
(43) Pub. Date: Feb. 3, 2022

(54) SYSTEM AND METHOD FOR GENERATING, ASSIGNING, AND ORGANIZING DATABASE VALUES ON AN INTERACTIVE PLATFORM

(71) Applicant: SPC Enterprises Corp., San Diego, CA (US)

(72) Inventor: Rudy Villareal, San Diego, CA (US)

(21) Appl. No.: 17/389,929

(22) Filed: Jul. 30, 2021

Related U.S. Application Data
(60) Provisional application No. 63/059,039, filed on Jul. 30, 2020.

(51) Int. Cl. G06Q 30/02; G06F 16/22

(52) U.S. Cl. CPC G06Q 30/0246; G06F 16/2291

(57) ABSTRACT

The present disclosure is directed to a system and method for generating, assigning, and organizing database values for use with social media platforms.

### CROSS-REFERENCE TO RELATED APPLICATIONS

This Non-Provisional Application claims the benefit of and priority to U.S. Provisional Patent Application No. 63/059,039, filed on Jul. 30, 2020, by inventor Rudy Villareal, the contents of which are expressly incorporated herein by this reference.

### FIELD OF USE

The present disclosure relates generally to system and method for generating, assigning, and organizing database values on an interactive platform. More specifically, the present disclosure relates to a system and method of generating custom influence indices on interactive platforms based on activities taken within the interactive platform.

### BACKGROUND

Social media platforms tend to concentrate the vast majority of influence and decision making in a very small subset of its users or owners, even though social media platforms tend to claim to create a community. Often, this small subset of individuals may advance their own interests and agenda ahead of the majority of the social media platform's users.

While some users gain monetary benefit from social media platforms, this monetary benefit is solely determined by the owners of the social media platform.

Thus, what is needed is a new and/or improved system and method for generating, assigning, and organizing specific database values for use with social media platforms to decentralize power.

### SUMMARY

The following presents a simplified overview of the example embodiments in order to provide a basic understanding of some embodiments of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented hereinbelow. It is to be understood that both the following general description and the following detailed description are exemplary and explanatory only and are not restrictive.

In accordance with the embodiments disclosed herein, the present disclosure is directed to a system and method for generating, assigning, and organizing database values on an interactive platform and then assigning ownership interests of the interactive platform based on the database values. In some embodiments, the database values may be based on activities taken by individuals that use the interactive platform. Additionally, the ability to censor or otherwise affect what content is posted on the interactive platform is based on a user's ownership interest up the interactive platform. in this manner, no single individual or entity is able to censor other individuals. It may be instead, the community as a whole, that determines what content is acceptable.

Still other advantages, embodiments, and features of the subject disclosure will become readily apparent to those of ordinary skill in the art from the following description wherein there is shown and described a preferred embodiment of the present disclosure, simply by way of illustration of one of the best modes best suited to carry out the subject disclosure As it will be realized, the present disclosure is capable of other different embodiments and its several details are capable of modifications in various obvious embodiments all without departing from, or limiting, the scope herein. Accordingly, the drawings and descriptions will be regarded as illustrative in nature and not as restrictive.

### DETAILED DESCRIPTION OF THE ILLUSTRATIVE EMBODIMENTS

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

The present systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware embodiments. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, compact discs, read-only-memory (CD-ROMs), optical storage devices, or magnetic storage devices.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, may be implemented by special purpose hardware-based computer systems that perform the specified functions or steps, or combinations of special purpose hardware and computer instructions.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 0.001-10% from the indicated number or range of numbers.

Various embodiments are now described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

In one embodiment, an inquiry may be made, wherein a response is expected. Rather than have the inquiry directed to a human for response, the inquiry may be processed or analyzed by incoming communication software. The incoming communication software may determine what additional information may be necessary for a human to provide a more complete response, and may generate a response communication to elicit additional information. This response communication may be based on an analysis for a meta-language that describes the message insightfully, and may utilize mnemonics to do so.

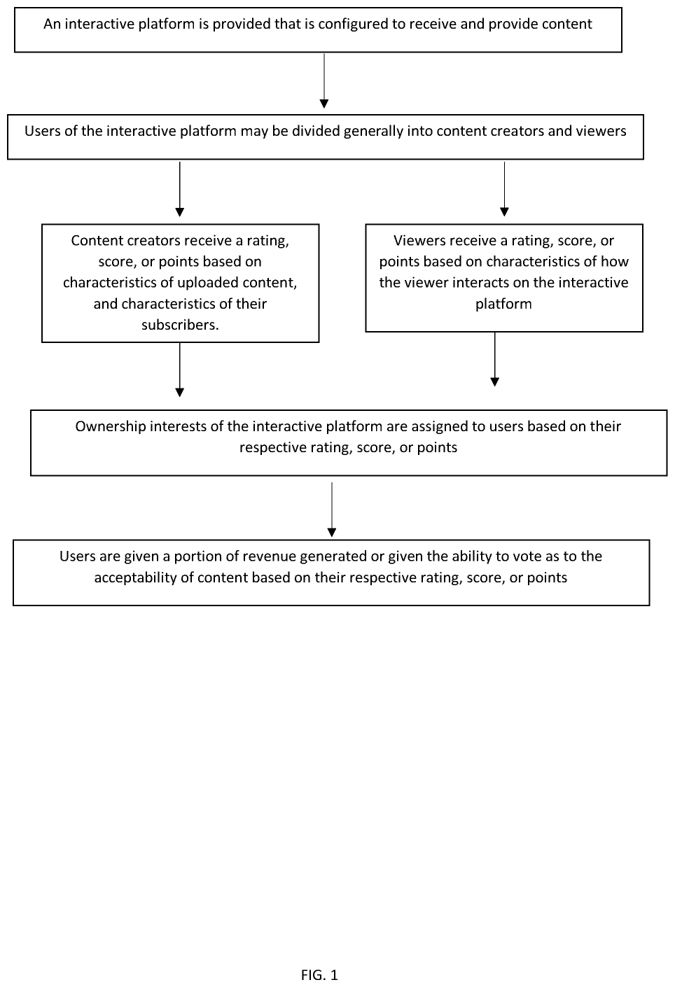

FIG. 1 is a flow diagram that shows how activity ratings may be generated.

First, an interactive platform may be provided that is configured to receive and provide content. In some embodiments, this interactive platform may be a social media platform.

Users of the interactive platform may be divided generally into content creators and viewers. In some instances a specific individual may be both a content creator and a viewer.

Individuals may be assigned values based on their actions on the interactive platform.

For example, content creators may receive a rating, score, or points based on characteristics of uploaded content, and characteristics of their subscribers. Some aspects of uploaded content that may be used to assign a rating, score, or points to the content creator may comprise the number of uploaded content, the frequency of uploading content, the length of uploaded content, the number of views of uploaded content, and engagement of viewers with the uploaded content.

Viewers may also receive a rating, score, or points based on characteristics of how the viewer interacts on the interactive platform. Some aspects of viewer interaction that may be used to assign a rating, score, or points may comprise content viewed, subscriptions to content creators, comments on content, likes on content, dislikes on content, time viewing content, Clicks on advertisements, purchases based on advertisements, identification of unsuitable (or flagged) content.

Ownership interests of the interactive platform may be assigned to content creators, and/or viewers based on their respective rating, score, or points.

In some embodiments, a specific percentage of ownership may be divided amongst content creators and viewers. For example, of a possible 100% ownership over the interactive platform, content creators may receive a total ownership interest of 20% while viewers receive a total ownership interest of 80%.

In an alternate embodiment, of a possible 100% ownership interest over the interactive platform, 51% may be owned by a single entity, such as the creator of the interactive platform, and 49% may be owned by the combination of content creators and viewers. in this embodiment, content creators and viewers may be assigned points as described herein above, where in that particular content creator or viewer's ownership interest of the interactive platform may be calculated by multiplying the total 49% possible ownership interest by the number of points the content creator or viewer has received divided by the total number of points obtained by all content creators and viewers combined. In alternate embodiments, the percentage ownership of a single entity and the combination of content creators and viewers with respect to the interactive platform may be substantially any amount provided that the total ownership interest adds up to 100%. In some embodiments, when an entity or individual has a de minimus ownership interest in the interactive platform, which may be a predetermined amount, their ownership interest may be rounded down to 0%, and distributed to other owners.

In one embodiment, revenue generated by the interactive platform may be distributed to all entities and/or individuals that have an ownership interest in the interactive platform based on their ownership interest percentage.

In one embodiment, individuals may be given the ability to flag, report, or otherwise censor content that is uploaded to the interactive platform.

Individuals may vote to make content viewable or not viewable, and the content may be made not viewable if a certain threshold is reached. The threshold may be predetermined. In one embodiment, the threshold may be a majority of the ownership interest or a majority of the ownership interest that has voted on whether to make the content viewable or not viewable. In some embodiments, if the threshold to make the content not viewable is reached, the content may be made not viewable, but individuals may still have the ability to vote on whether or not to censor, such that the content may become viewable once again.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and in the claims, the singular form of “a”, “an”, and “the” include plural referents unless the context clearly dictates otherwise.

Unless otherwise stated, all measurements, values, ratings, positions, magnitudes, sizes, locations, and other specifications that are set forth in this specification, including in the claims that follow, are approximate, not exact. They are intended to have a reasonable range that is consistent with the functions to which they relate and with what is customary in the art to which they pertain.

In addition, the various illustrative logical blocks, modules, and circuits described in connection with certain embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, system-on-a-chip, or state machine. A processor may also be implemented as a combination of computing devices, e.g., a combination of a DSP and a microprocessor, a plurality of microprocessors, one or more microprocessors in conjunction with a DSP core, or any other such configuration.

Operational embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, a DVD disk, or any other form of storage medium known in the art. An exemplary storage medium is coupled to the processor such the processor may read information from, and write information to, the storage medium. In the alternative, the storage medium may be integral to the processor. The processor and the storage medium may reside in an ASIC or may reside as discrete components in another device.

Furthermore, the one or more versions may be implemented as a method, apparatus, or article of manufacture using standard programming and/or engineering techniques to produce software, firmware, hardware, or any combination thereof to control a computer to implement the disclosed embodiments. Non-transitory computer readable media may include but are not limited to magnetic storage devices (e.g., hard disk, floppy disk, magnetic strips), optical disks (e.g., compact disk (CD), digital versatile disk (DVD)), smart cards, and flash memory devices (e.g., card, stick). Those skilled in the art will recognize many modifications may be made to this configuration without departing from the scope of the disclosed embodiments.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those of ordinary skill in the art that various modifications and variations may be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A computer-implemented system for generating, assigning, and organizing database values, comprising:
a system server;
wherein said system server comprises an interactive platform;
wherein said interactive platform is configured to allow a plurality of users to interact with one another on said interactive platform through one or more interactive mechanisms;
wherein said users comprise content providers and viewers;
wherein said interactive platform comprises a database configured to catalog actions taken by said content providers and said viewers;
wherein said actions cataloged comprise uploads, subscriptions, views, likes, dislikes, comments, duration of video uploaded, duration of video viewed, clicks on advertisements, purchases based on advertisements, and votes on content;
wherein said content creators and viewers are assigned an activity rating based on said actions cataloged;
where in an ownership percentage of said interactive platform is assigned to said content providers and said viewers based on said activity rating.
